(19) United States
(12) Patent Application Publication
(10) Pub. No.: US 2014/0160049 A1
(43) Pub. Date: Jun. 12, 2014

(54) CLIPBOARD FUNCTION CONTROL METHOD AND APPARATUS OF ELECTRONIC DEVICE

(71) Applicant: Samsung Electronics Co., Ltd., Gyeonggi-do (KR)

(72) Inventor: Sangmin SHIN, Gyeonggi-do (KR)

(73) Assignee: Samsung Electronics Co., Ltd., Gyeonggi-do (KR)

(21) Appl. No.: 14/102,040

(22) Filed: Dec. 10, 2013

(30) Foreign Application Priority Data
Dec. 10, 2012 (KR) 10-2012-0142490
Dec. 10, 2013 (KR) 10-2013-0152751

(51) Int. Cl. G06F 3/01; G06F 3/041

(52) U.S. Cl. CPC G06F 3/017; G06F 3/0412
USPC 345/173

(57) ABSTRACT

A clipboard function control method and apparatus of an electronic device is provided for copying at least one object into a clipboard and pasting the at least one copied object selectively according to a user input. The method includes detecting a user gesture on a page, checking a number of touch points of the user gesture, processing an object in association with the number of touch points of the user gesture, where the processing of the object is one of storing the object in association with the number of touch points as clipped data and pasting the clipped data identified with the number of touch points.

### PRIORITY

This application claims priority under 35 U.S.C. §119(a) to Korean Patent Application Serial Nos. 10-2012-0142490 and 10-2013-0152751 filed on Dec. 10, 2012 and Dec. 10, 2013, respectively, in the Korean Intellectual Property Office, the entire disclosure of which is incorporated herein by reference.

### BACKGROUND OF THE INVENTION

1. Field of the Invention

The present invention generally relates to a clipboard function control method and apparatus of an electronic device, and more particularly, to a clipboard function control method and apparatus for copying at least one object into a clipboard and pasting at least one copied object selectively according to a user input.

2. Description of the Related Art

With the advance of digital technology, various types of electronic devices, such as mobile communication terminals, Personal Digital Assistants (PDAs), smartphones, and tablet Personal Computers (PCs), are capable of communication and of processing personal information.

The electronic device is capable of supporting various functions including messaging functions (such as Short Message Service (SMS)/Multimedia Message Service (MMS)), video conference, electronic organizer, photography, email, broadcast playback, video playback, Internet, electronic transaction, audio playback, schedule organizer, Social Network (Service), messenger, dictionary, game, clipboard, etc.

Touch screen enabled electronic devices, in particular, have recently become widespread. The touch screen has made it possible to overcome the shortcomings of the conventional input method (e.g. physical keypad) and has allowed the user to use the electronic device more conveniently than before. For example, the touchscreen-enabled electronic device is capable of detecting the user touch gesture (e.g. input gesture such as touch or hovering) made on the touch screen with a touch tool (e.g. hand or stylus pen) to generate a corresponding input signal.

The touch screen based clipboard function manipulation (e.g. copy & paste and cut & paste) is useful in the electronic device. Conventional electronic devices support a single clipboard function for clipping per object and multi-clipboard function capable of copying a plurality of objects into the clipboard and pasting the copied objects selectively. In the case of the single clipboard function, the user is capable of copying, cutting and pasting an object one at a time. However, the multi-clipboard function allows for copying a plurality of objects according to the user input and pasting the objects one by one in the order as selected by the user.

In order to copy and paste a plurality of objects using the single clipboard function, the user has to repeat a series of actions for copying/cutting an object, designating a position to paste (or designating the position after screen-switching), and pasting the object onto the position. In order to copy and paste a plurality of objects using the multi-clipboard function, it is possible to process the plurality objects by repeating a series of actions of copying/cutting, designating positions to paste (or screen-switching), invoking the clipboard, selecting one of the objects from the clipboard, and pasting the selected object onto the target position. Accordingly, the number of manipulation operations increases in proportion to the number of objects to be copied and pasted.

### SUMMARY

The present invention has been made to address at least the problems and disadvantages described above, and to provide at least the advantages described below. The conventional electronic device has a drawback in that the complex and repetitive manipulation operations processing a plurality of objects make it difficult for the user to use the clipboard function.

An aspect of the present invention is to provide a clipboard function control method and apparatus of an electronic device that is capable of using the clipboard function intuitively in simple and quick manner.

Another aspect of the present invention also is to provide a clipboard function control method and apparatus of an electronic device that is capable of storing the objects to be copied or cut in match with the user input (e.g. touch) having touch points different in number.

Another aspect of the present invention also is to provide a clipboard function control method and apparatus of an electronic device that is capable of storing the copied or cut objects matching with a specific number of touch points input as one finger, two fingers, and three fingers-based touch inputs.

A further aspect of the present invention also is to provide a clipboard function control method and apparatus of an electronic device that is capable of pasting a plurality of objects stored in the clipboard selectively according to the number of touch points of the touch input.

An additional aspect of the present invention also is to provide a clipboard function control method and apparatus of an electronic device that is capable of facilitating execution of the clipboard function for processing a plurality of objects according to the user input made in sequence corresponding to the number of touch points.

Another aspect of the present invention also is to provide a clipboard function control method and apparatus of an electronic device that is capable of implementing an environment for supporting the clipboard function, resulting in improvement of user convenience and device usability.

In accordance with an aspect of the present invention, a clipboard function control method of an electronic device is provided. The clipboard function control method includes detecting a user gesture on a page, checking a number of touch points of the user gesture, processing an object in association with the number of touch points of the user gesture, where the processing of the object is one of storing the object in association with the number of touch points as clipped data and pasting the clipped data identified with the number of touch points.

In accordance with another aspect of the present invention, a clipboard function control method of an electronic device is provided. The clipboard function control method includes detecting a user gesture made on a page, determining a type of the user gesture and a number of touch points of the user gesture, clipping, when the user gesture is a clip gesture made at an object area, an object in response to the clip gesture, storing the clipped object in association with the number of touch points, and pasting, when the user gesture is a paste gesture made at a paste area, the object identified with the number of touch points at the paste area.

In accordance with another aspect of the present invention, a computer-readable storage medium records a program for executing the above method with one or more processors.

In accordance with another aspect of the present invention, an electronic device is provided. The electronic device includes a display panel which displays a page, a storage unit which has a clipboard for storing one or more clipped data, and a control unit which controls storing an object clipped in response to a user gesture made on the page in association with a number of the user gesture and invoking the clipped data identified with the number of touch points of the user gesture from the clipboard for pasting.

In accordance with still another aspect of the present invention, an electronic device is provided. The electronic device includes a display panel which displays a page, a touch panel which detects a user gesture, a storage unit which stores at least one processor which executes at least one program to control the clipboard function of the electronic device, wherein the at least one program includes detecting a user gesture made on a page, determining a type of the user gesture and a number of touch points of the user gesture, clipping, when the user gesture is a clip gesture made at an object area, an object in response to the clip gesture, storing the clipped object in association with the number of touch points, and pasting, when the user gesture is a paste gesture made at a paste area, the object identified with the number of touch points at the paste area.

### BRIEF DESCRIPTION OF THE DRAWINGS

The above and other aspects, features, and advantages of embodiments of the present invention will be more apparent from the following detailed description taken in conjunction with the accompanying drawings, in which:

FIG. 1 is a block diagram illustrating a configuration of the electronic device according to an embodiment of the present invention;

FIGS. 2 and 3 are diagrams illustrating screen displays for explaining a procedure of clipping objects in response to user touch gestures in the electronic device according to an embodiment of the present invention;

FIG. 4 is a diagram illustrating a user touch gesture made to the electronic device according to an embodiment of the present invention;

FIGS. 5 and 6 are diagrams illustrating screen displays of clipboard operations in the electronic device according to an embodiment of the present invention;

FIGS. 7 and 8 are diagrams illustrating screen displays of pasting clipped data in response to a user input in the electronic device according to an embodiment of the present invention;

FIG. 9 is a flowchart illustrating a clipboard function control method of the electronic device according to an embodiment of the present invention;

FIG. 10 is a flowchart illustrating a clipboard function control method of an electronic device according to an embodiment of the present disclosure;

FIG. 11 is a flowchart illustrating a clipboard function control method of an electronic device according to an embodiment of the present disclosure; and

FIG. 12 is a flowchart illustrating the step of pasting an object in response to the paste gesture of the user.

The same reference numerals are used to represent the same elements throughout the drawings.

### DETAILED DESCRIPTION OF EMBODIMENTS OF THE PRESENT INVENTION

Embodiments of the present invention are described with reference to the accompanying drawings in detail. The same reference numbers are used throughout the drawings to refer to the same or like parts. Detailed description of well-known functions and structures incorporated herein may be omitted to avoid obscuring the subject matter of the present invention.

In the following, a description is made of the configuration of an electronic device and control method thereof according to an embodiment of the present invention with reference to accompanying drawings. It should be noted that the configuration of an electronic device and control method thereof according to an embodiment of the present invention is not limited to the following description but may be embodied in alternative embodiments. The description is directed to the hardware-based implementation in the following embodiments. However, the present invention can be implemented based on both the hardware and software configuration but does not exclude any software-based implementation.

In an embodiment of the present invention, the electronic device may be any of all the types of information communication and multimedia devices including a Tablet Personal Computer (PC), mobile communication terminal, mobile phone, video phone, Personal Digital Assistant (PDA), Portable Multimedia Player (PMP), electronic boor (e-book) reader, smartphone, desktop PC, laptop PC, netbook computer, MP3 player, camera, wearable device (e.g. head-mounted-device (HMD) such as electronic glasses), electronic clothing, electronic bracelet, electronic appcessory, electronic tattoo, smart watch, digital broadcast terminal, and Automated Teller Machine (ATM), etc.

According to an embodiment, the electronic device may be a smart home appliance having a communication function. The smart home appliance may be any of a television, Digital Video Disk (DVD) player, audio, refrigerator, game consoles, electronic dictionary, electronic key, camcorder, and electronic frame.

According to an embodiment, the electronic device may be any of a medical device (e.g. Magnetic Resonance Angiography (MRA), Magnetic Resonance Imaging (MRI), Computed Tomography (CT)), Navigation device, Global Positioning System (GPS) receiver, Event Data Recorder (EDR), Flight Data Recorder (FDR), car infotainment device, maritime electronic device (e.g. maritime navigation device and gyro compass), aviation electronic device (avionics), security device, industrial device, and home robot.

According to an embodiment, the electronic device may be any of furniture and building/structure having a communication function, an electronic board, electronic signature receiving device, projector, and metering device (e.g. water, electric, gas, and electric wave metering devices).

According to an embodiment, the electronic device may be any combination of the aforementioned devices. It will be obvious to those skilled in the art that the electronic device is not limited to the aforementioned devices.

An embodiment of the present invention provides an electronic device and control method that is capable of copying/cutting one or more objects into the clipboard and pasting the objects to a target place in response to a user input.

In the following description, the step of copying or cutting one or more objects is expressed with the word ‘clip’, and the data copied or cut into the clipboard is referred to as ‘clipped data’. In an embodiment of the present invention, an object may be any of various kinds of elements presented on the page (screen) of one or more applications which is displayed by a display unit. For example, the object may be any of image, text, data (e.g. character such as symbol and emoticon, tag, coded label (e.g. barcode) readable by electronic device, Uniform Resource Locator (URL), and content (e.g. video file, audio file, and document file).

In an embodiment of the present invention, the step of generating clipped data (e.g. copying or cutting one or more objects into the clipboard) and pasting the clipped data is performed based on touch-based user input. In an embodiment of the present invention, however, the clipboard function may be performing based on the user input made with hovering gestures.

In an embodiment of the present invention, a user input for executing (operating) the clipboard function may consist of a first user input for generating a clipped data from one or more objects (e.g. referred to as first touch or copy touch) and a second user input for invoking the clipped data from the clipboard and pasting the data onto a target position of a page (e.g. referred to as second touch or paste touch). Although the first and second user inputs are differentiated for explanation and convenience herein, they may be made in the same gesture.

Accordingly, the user may make the same gesture to generate and paste the clipped data. For example, the user may generate the clipped data with one finger-based gesture made to a certain object on the page and paste the clipped data onto another area (e.g. empty area of the page for pasting the clipped data or data input area) of the page with the same one finger-based gesture. According to an embodiment of the present invention, if the user gesture is detected on an object, the user gesture is determined as a user input for generating the clipped data; and if the user gesture is detected on an empty area such as paste area (e.g. empty area or data paste area), the user gesture is determined as a user input for pasting the data.

According to an embodiment of the present invention, the user input for clipboard function control may be made with one of a long press gesture, a double-tap gesture, a pattern-based gesture interaction. According to an embodiment of the present invention, the user input is made with a touch gesture having at least one touch point, and user inputs for generating and pasting the clipped data may be the same gesture or different gestures. For example, it may be configured that both the clipped data generation and paste operations are performed with the same input pattern (e.g. long press). Also, it may be configured that the clipped data generation is performed with the first input pattern (e.g. long press) and the clipped data pasted with the second pattern (e.g. pattern-based gesture).

According to an embodiment of the present invention, the user's input gesture may have one or more touch points. According to an embodiment of the present invention, the clip board function may operate with a single touch gesture having one touch point and a multi-touch gesture having a plurality of touch points. The user may generate one or more clipped data according to the user touch gesture having one or more touch points and paste one or more clipped data according to the user touch gesture having one or more touch points. According to an embodiment, the user may operate the clipboard function with the one finger, two fingers, and three fingers-based tough gestures.

For this purpose, the electronic device according to an embodiment of the present invention may detect a number of touch points of the user touch gesture (e.g. first touch or clip touch) made onto each object and store the object with a tag indicating the number of touch points in the storage (e.g. clipboard). The electronic device also detect the number of touch points of the user touch gesture (e.g. second touch or paste touch) made at the paste area, invoke (extract) the clipped data having the indication of the number of touch points, and pastes the invoked clipped data to the paste area.

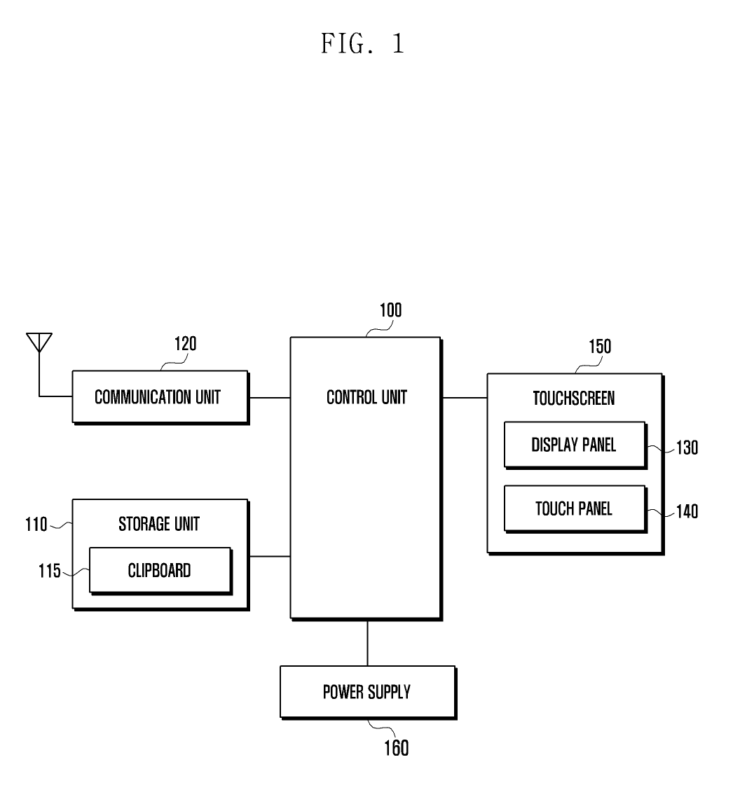

FIG. 1 is a block diagram illustrating a configuration of the electronic device according to an embodiment of the present invention.

Referring to FIG. 1, the electronic device includes a communication unit 120, a storage unit 110, a touchscreen 150, a control unit 100, and a power supply 160. According to an embodiment of the present invention, the electronic device may include further components or without any of the components depicted in FIG. 1.

According to an embodiment of the present invention, the electronic device may include various sensors (e.g. voice recognition sensor, infrared sensor, acceleration sensor, gyro sensor, terrestrial magnetism sensor, illuminance sensor, color sensor, image sensor, temperature sensor, proximity sensor, motion recognition sensor, and pressure sensor), a Wireless Local Area Network (WLAN) module for supporting wireless Internet, a short range communication module for supporting various short range communication technologies (e.g. Bluetooth, Bluetooth Low Energy (BLE), Near Field Communication (NFC), Radio Frequency Identification (RFID), and Infrared Data Association (IrDA)), a broadcast reception module for receiving broadcast signals from external broadcast management server through broadcast channel (e.g. satellite and terrestrial broadcast channels).

The communication unit 120 is responsible for wireless communication (e.g. voice communication, video communication, and data communication) with a base station or other external devices (e.g. server and other electronic devices). The communication unit 120 may include a transmitter for up-converting and amplifying the transmission signal and a receiver for low noise amplifying and down-converting the received signal. The transmission unit 120 may include at least one module for supporting wireless communication with another electronic device through a cellular communication network (e.g. LTE, LTE-A, WCDMA, and GSM), Internet Protocol network (e.g. Wi-Fi), and short range communication network (e.g. Bluetooth). For example, the communication unit may include at least one of a cellular communication module, a WLAN module, a short range communication module, a location calculation module, and a broadcast reception module.

The storage unit 110 may store one or more programs for processing and controlling of the control unit 100 and input/output data (e.g. messenger data (e.g. chat data), contact information (e.g. wired or wireless phone number), message, and contents).

The one or more programs may include the programs of detecting user input made on a page; determining type of user gesture and number of touch points; clipping, when the user gesture is the clip gesture made on an object, the corresponding object; storing the clipped object with a tag of the number of touch points; and pasting, when the user gesture is the paste gesture made on a paste area, the object corresponding to the number of touch points of the paste gesture.

The storage unit 110 may store one or more clipped data and include a clipboard 115. In an embodiment of the present invention, the clipped data may be stored with a tag indicating the number of touch points of the user gesture made to clip the data (e.g. one finger, two fingers, and three fingers-based).

The storage unit 110 may include at least one of various types of storage media including flash memory type, hard disk type, micro type, and card type (e.g. Secure Digital Card) or eXtream Digital Card (XD)) memories, Dynamic Random Access Memory (DRAM), Static RAM (SRAM), Read-Only Memory (ROM), Programmable ROM (PROM), Electrically Erasable PROM (EEPROM), Magnetic RAM (MRAM), magnetic disk, and optical disk. The electronic device may operate in association with a web storage, performing storage function of the storage unit 110 on the Internet.

The control unit 100 controls overall operations of the electronic device. For example, the control unit 100 may control voice, video, and data communications. According to an embodiment of the present invention, the control unit 100 may control the clipboard function based on the number of touch points of a touch gesture and may include a data processing module (not shown) for processing the touch gesture. The data processing module may be stored (loaded) in one of the storage unit 110 and the control unit 100 or implemented as an independent component. The control unit 100 may be implemented with one or more processors for executing one or more programs stored in the storage unit 110 to control the clipboard function of the present invention.

In an embodiment of the present invention, the control unit 100 may control the clipboard function according to the user touch gestures having different number of touch points. For example, the control unit 100 may execute one or more applications to control the display unit 130 to display a related page (screen). If a user touch gesture is detected on the page, the control unit 100 determines whether the user touch gesture is made onto an object area or a paste area (e.g. empty area or data input area). If the user touch gesture is detected at the object area, the control unit 100 determines the user touch gesture as the input for selecting the object to generate clipped data (e.g. first touch or clip touch). If the user touch gesture is detected at the paste area, the control unit 100 determines the user touch gesture as the input for pasting the clipped data to the corresponding area (e.g. second touch or paste touch).

If it is determined that the user touch gesture is the input gesture for generating the clipped data, the control unit 100 detects a number of touch points of the touch gesture. The control unit 100 clips (copies or cuts) the object selected by the user input to generate the clipped data and stores the clipped data with a tag indicating the number of touch points into the clipboard 115.

If it is determined that the user touch gesture is the input gesture for pasting the clipped data, the control unit 100 detects a number of touch points of the touch gesture. The control unit 100 invokes (extracts) the clipped data corresponding to the number of touch points from the clipboard 115 and pastes the clipped data at the paste area where the user touch gesture is detected.

The touchscreen is an input/output means capable of receiving any input and displaying output data simultaneously and may include a display panel 130 and a touch panel 140. The touchscreen 150 may display various screen related to the step of the electronic device (e.g. messenger screen, call-placing screen, game screen, motion picture playback screen, gallery application screen, messaging screen, webpage screen, list screen, and email application screen). If a user gesture (e.g. a touch gesture having one or more touch points) is detected on the touch panel 140 in the state that a specific screen is displayed on the display panel 130, the touch panel 140 may generate an input signal corresponding to the user gesture to the control unit 100. The control unit 100 may identify the user input and control execution of the step (e.g. clipboard function) corresponding to the user input.

The display unit 130 may display (output) the information processed in the electronic device. For example, the display unit 130 may display the information (e.g. page including objects) of the application executed under the control of the control unit 100. The display unit 130 may support landscape and portrait mode screen displays and switching between the landscape and portrait screen display modes in accordance with change in posture of the electronic device.

The display unit 130 may be implemented with one of Liquid Crystal Display (LCD), Thin Film Transistor LCD (TFT LCD), Light Emitting Diodes (LED), Organic LED (OLED), Active Matrix OLED (AMOLED), flexible display, bended display, and 3-Dimensional (3D) display. At least one of these displays may be implemented in the form of a transparent display.

The touch panel 140 may detect the user gesture (e.g. tap, drag, sweep, flick, drag and drop, drawing, single touch, multi-touch, gesture (e.g. writing), and hovering) made on the surface of the touch screen 150. If a user gesture is detected on the surface of the touch screen 150, the touch panel 150 detects the coordinates at the touch point(s) and sends the coordinates to the control unit 100. That is, the touch panel 140 detects the user touch gesture with one or more touch points and generates a signal(s) to the control unit 100. The control unit 100 controls to execute a function corresponding to the user touch gesture based on the signal(s) from the touch panel 140.

The touch panel 140 is configured to convert change in pressure and capacitance at a certain position of the display panel 130 to an electric input signal. The touch panel 140 may be configured to detect the pressure as well as the position and size of the touch. For example, the touch panel 140 may be implemented as a resistive type, capacitive type, and/or electromagnetic type touch panel. The touch panel 140 may detect the user input made with various input means (e.g. finger or stylus pen) and generates corresponding signal(s) to the control unit 100 such that the control unit 100 check the area where the touch gesture is detected on the touch screen based on the signal(s).

The power supply 160 supplies power of the external or internal power source to the components of the electronic device.

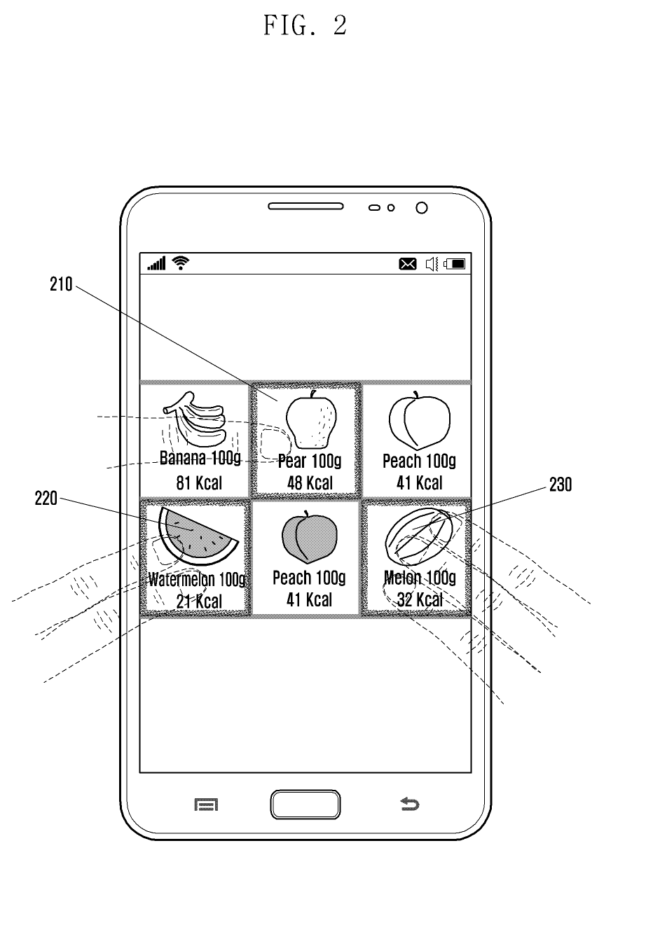

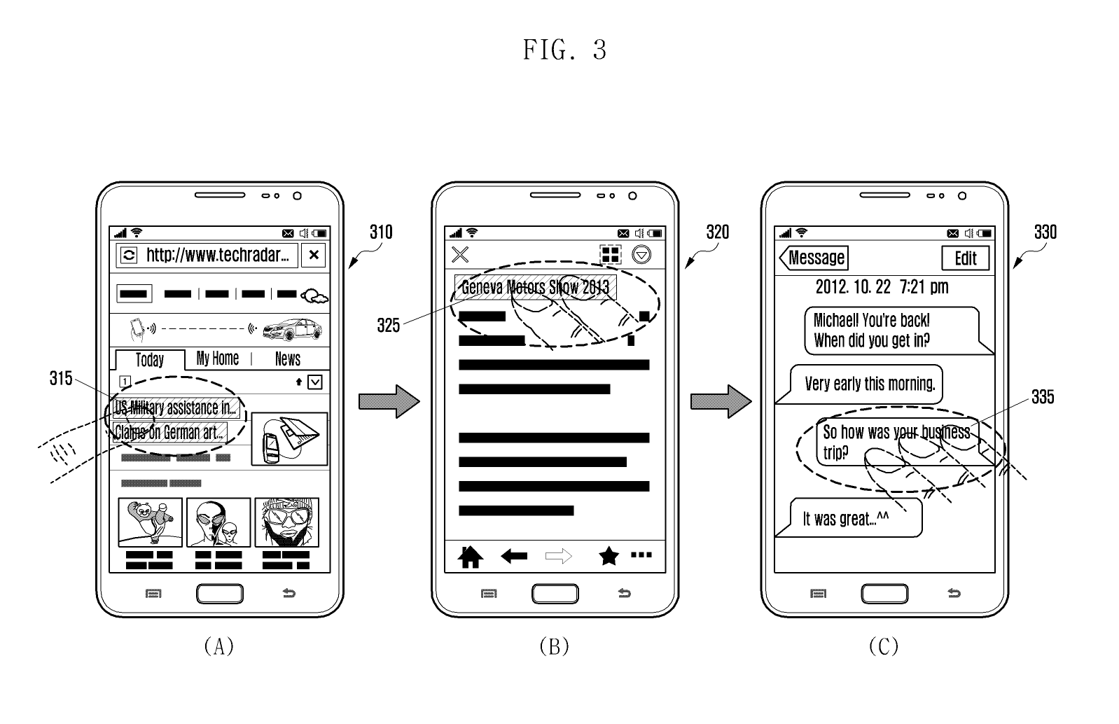

FIGS. 2 and 3 are diagrams illustrating screen displays for explaining a procedure of clipping objects in response to the user touch gestures in the electronic device according to an embodiment of the present invention. Although the description is directed to the case where the user touch gesture is made with finger(s) and/or touch pen (e.g. stylus pen) in the following description, other means may be used for making a user touch input on the touch panel 140.

Referring to FIGS. 2 and 3, the control unit 100 may detect the user gesture made to an object at the object area on the page displayed by the display panel 130. The user touch gesture having one or more touch points may be made to clip (e.g. copy or cut) the object at the object area. The user touch gesture may be made in the form of a touch onto the object area or hovering above the object area. The user touch gesture may be made onto plural objects in series with different touch points. As shown in FIG. 2, the user touch gestures different in number of touch points are made onto the different objects presented on the page displayed by the display panel 130.

For example, the user may make a touch gesture having one touch point (e.g. one finger-based single touch) to select and clip an image 210. The control unit 100 stores the clipped pear image 210 with a tag indicating the number of touch points (e.g. one) as the first clipped data.

The user also may make a touch gesture having two touch points (e.g. two fingers-based multi-touch) to select and clip a watermelon image 220 after clipping the pear image 210. The control unit 100 stores the clipped watermelon image 220 with a tag indicating the number of touch points (e.g. two) as the second clipped data.

The user also may make a touch gesture having three touch points (e.g. three fingers-based multi-touch) to select and clip a melon image 230. The control unit 100 stores the clipped melon image 230 with a tag indicating the number of touch points (e.g. three) as the third clipped data.

As a result, the clipboard 115 stores a plurality of clipped data, i.e. the first, second, and third clipped data differentiated with number of touch points.

As shown in FIG. 2, the objects clipped by the user input may be the objects distributed on a page (e.g. application execution screen) displayed by the electronic device. For example, a plurality of objects (e.g. pear image 310, watermelon image 320, and melon image 330) may be clipped from one execution screen.

According to an embodiment of the present invention, the plural objects clipped in accordance with the user input may be the objects distributed on different pages (e.g. execution screens of different applications). For example, a plurality objects may be clipped from different execution screens as shown in FIG. 3.

As shown in FIG. 3, the objects 315, 325, and 335 are clipped from the first application (e.g. Internet Browser) execution screen 310, the second application (e.g. electronic document application) execution screen 320, and the second application (e.g. messaging application) execution screen 330.

As shown in part (A) of FIG. 3, the user may make a touch gesture with a single touch point (e.g. single finger touch) on the first application execution screen 310 to clip the object 315. In response to the user touch gesture, the control unit 100 stores the selected object 315 with a tag indicating the number of touch points (i.e. 1) as the first clipped data.

As shown in part (B) of FIG. 3, the user may switch the first application execution screen 310 to the second application execution screen 320 after clipping the object 315 from the first application execution screen 310. Then the user may make a touch gesture with two touch points (e.g. two-finger multi-touch) on the second application execution screen 320 to clip the object 325. In response to the user touch gesture, the control unit 100 stores the selected object 325 with a tag indicating the number touch points (i.e. 3) as the second clipped data.

As shown in part (C) of FIG. 3, the user may switch the second application execution screen 320 to the third application execution screen 330. Then the user may make a touch gesture with three touch points (e.g. three-finger multi-touch) on the third application execution screen 330 to clip the object 335. In response to the user touch gesture, the control unit 100 stores the selected object 325 with a tag indicating the number of touch points (i.e. 3) as the third clipped data.

As a result, the first, second, and third clipped data differentiated with the number of touch points are stored in the clipboard.

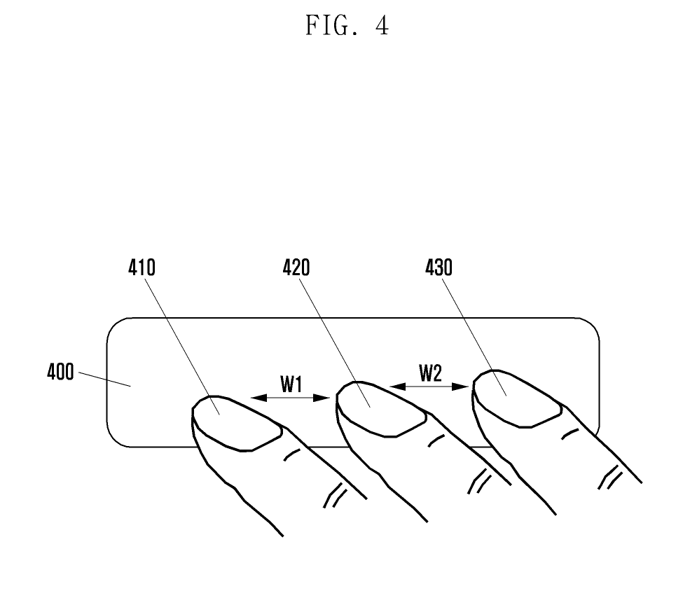

FIG. 4 is a diagram illustrating a user touch gesture made to the electronic device according to an embodiment of the present invention.

As shown in FIG. 4, the user tough gesture may be made with multiple touch points occurring simultaneously or in series in the object area 400. At this time, it may be difficult to make a multi-touch-based user touch gesture with multiple touch tools (e.g. fingers and stylus pen) due to the small size of the touch sensitive area. In an embodiment of the present invention, when the user attempts to make multi-touch gesture with two finger (e.g. long press), although the two fingers not touched simultaneously, if the touch is maintained for a predetermined duration, it can be regarded that the two fingers have touched simultaneously. For example, in the case that the touch points 410, 420, and 430 occur in series, if all of the touch points are detected during the predetermined duration (e.g. x seconds, x is natural number), those are processed as one user input gesture.

According to an embodiment, it is assumed that a touch gesture is made with three touch points 410, 420, and 430 occurring in series within a predetermined duration of 3 seconds. In this case, if the second and third touch points 420 and 430 are detected within 3 seconds of the detection of the first touch point 410, the control unit 100 regards that the first to third touch points 410 to 430 as constituting one user touch gesture and stores the object with a tag indicating three (3) touch points.

Here, the control unit 100 checks the number of touch points at the time when the 3 seconds have elapsed and classifies the object based on the number of touch points. The user may release on at least one (e.g. second touch point 420) of the touch points occurred in the three seconds before the expiry of the three seconds. In this case, although three touch points (the first to third touch points 410 to 430) have been detected, the control unit 100 classifies the object based on the number of touch points (e.g. first and third touch points 410 and 430) maintained at the expiration of the three seconds.

In an embodiment of the present invention, the predetermined time duration is configured for counting the touch points of the touch gesture made therein. According to an embodiment of the present invention, it may be possible to start counting the time duration at the time when a touch point is detected and, if another touch point is detected within the time duration, reset the time duration to recount. According to an embodiment of the present invention, the multi-touch gesture may consist of three touch points occurring at distances of W1 and W2. Here, the distances between touch points may have the relationship of W1=W2 or W1≠W2.

In an embodiment of the present invention, the number of touch points constituting the user touch gesture may be restricted according to the user's selection. For example, a user touch gesture may include up to 5 touch points in the case of using one hand or up to 10 touch points in the case of using both hands.

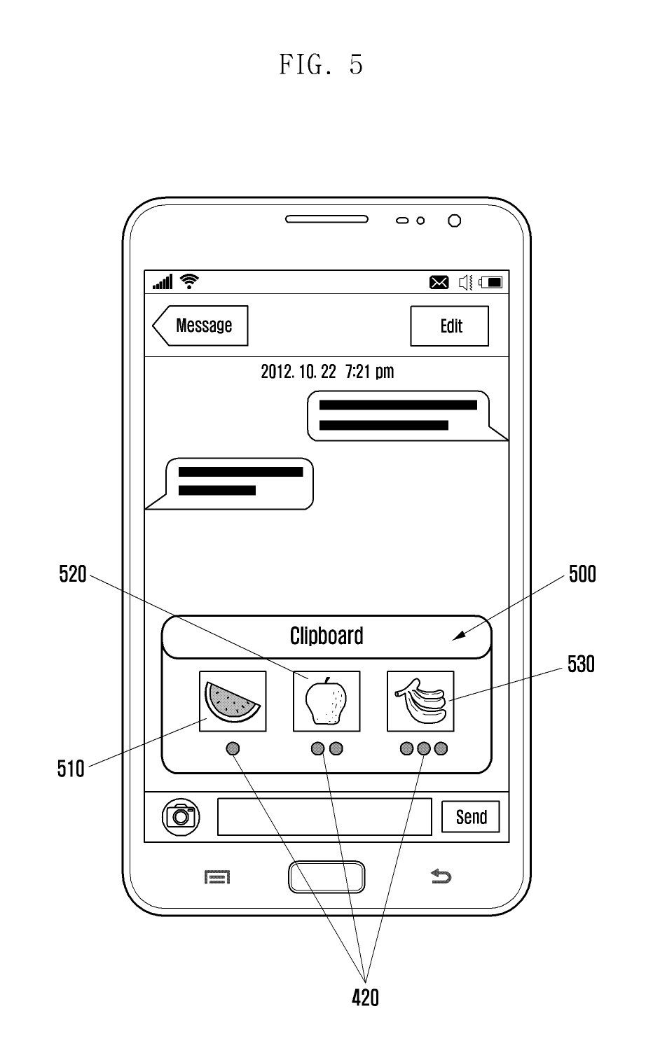

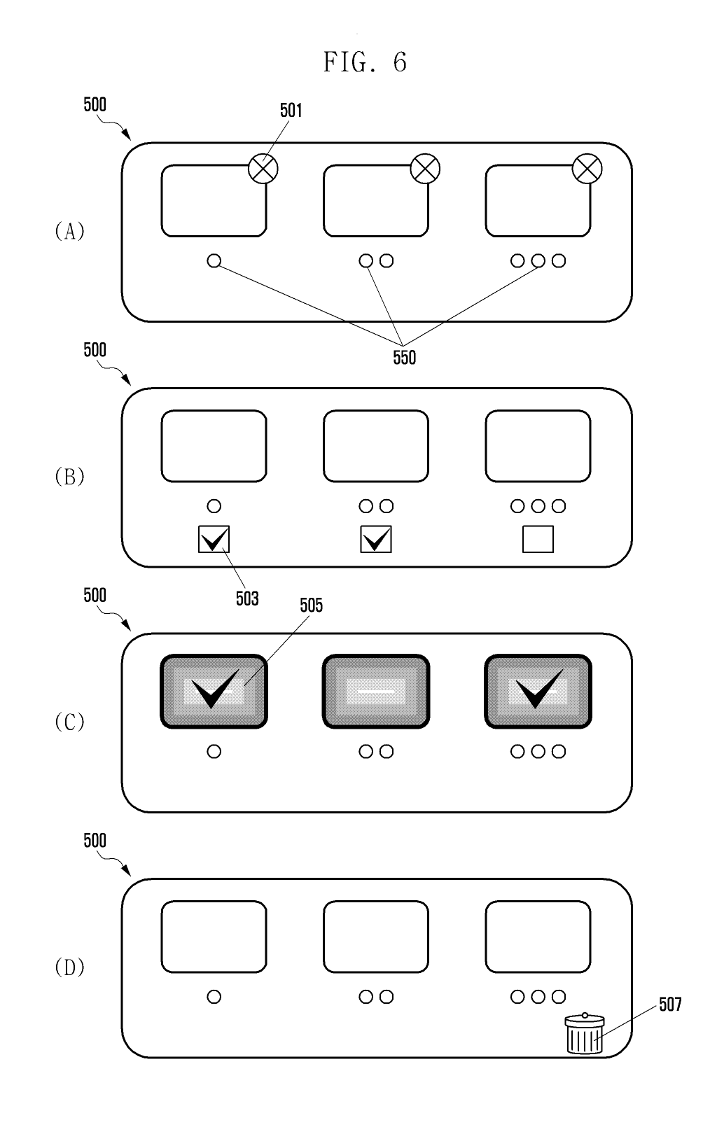

FIGS. 5 and 6 are diagrams illustrating screen displays of clipboard operations in the electronic device according to an embodiment of the present invention.

Each of the one or more objects clipped through the step as described with reference to FIGS. 2 and 3 is stored as the clipped data into the clipboard 115 along with a tag indicating the number of touch points. The clipboard function control method of the present invention may provide a function allowing the user to check the clipped data in real time.

Referring to FIG. 5, if a user input for calling a clipboard window 500 in the state that a specific page is displayed, the control unit 100 controls to display the clipboard window 500 at an area of the page (e.g. bottom or top of the screen, bottom right corner in right hand input mode, and bottom left corner in left hand input mode). In an embodiment of the present invention, the user input may be made with any of certain patterned gesture, menu item selection, hovering gesture, and clipboard window call icon selection.

Through the clipboard window 500, it is possible to provide items 510, 520, and 530 (e.g. image, icon, and text) corresponding to the one or more clipped data (copied or cut) on the clipboard 115. Although three clipped data are depicted in FIG. 5, more or less than the three clipped data may be arrange in the clipboard window. If there is no clipped data in the clipboard 115, no item is shown in the clipboard window 500. The clipboard window 500 may change (to expand or shrink horizontally and/or vertically) in size according to the number of items representing the clipped data (and/or feature size) (e.g. horizontal and vertical lengths).

According to an embodiment of the present invention, the information on the number of touch points which has been tagged to each clipped data (e.g. point icon (symbol) indicating the number of touch points) is provided along with the items 510, 520, and 530 corresponding to the clipped data. For example, the clipped data represented by the item 510 is identified with one touch point, the clipped data represented by the item 520 is identified with two touch points, and the clipped data represented by the item 530 is identified with three touch points. The number of touch points tagged to the clipped data is used to identify the corresponding clipped data.

In an embodiment of the present invention, the data clipped into the clipboard 115 may be stored persistently, semi-persistently, or temporarily according to the user configuration. In the case that the clipboard is configured for persistent storage, the clipboard keeps storing the clipped data unless it is deleted explicitly or another object is clipped with the same number of touch points. In the case that the clipboard is configured for semi-persistent storage, the clipped data is deleted automatically when a certain condition configured by the user is fulfilled (e.g. when the electronic device reboots) or a predetermined duration elapses (e.g. 10 hours, one day, one week, and one month). In the case that the clipboard is configured for temporal storage, the clipped data is deleted automatically after it is pasted to a target location.

According to an embodiment of the present invention, it is possible to delete the clipped data using the clipboard 500. For example, the user may perform manipulation for editing the clipped data in the state that the clipboard window 500 is displayed. According to an embodiment, the user may switch to the edit mode for editing the clipped data in response to a user input. The user input may occur with one of patterned gesture, menu item selection, hovering gesture, and clipboard window call icon selection.

If a user input for switching to the edit mode in the state that the clipboard window 500 is displayed, the control unit 100 switches the step mode to the edit mode capable of editing the clipped data and displays the corresponding screen. For example, the control unit 100 may control to display the edit mode screen for adding an edit items to items 510, 520, and 530 in the clipboard window 500, changing the shape (e.g. shadowing) of the items 510, 520, and 530, and adding a recycling bin item to the page. FIG. 6 shows an example of this.

Parts (A), (B), and (C) of FIG. 6 show the data items 510, 520, and 530 presented along with the edit items 501, 503, and 505 capable of allowing the data items selectively in the clipboard window 500.

As shown in part (A) of FIG. 6, the control unit 100 may control such that a delete icon 501 (e.g.) is presented at a side (e.g. edge) of each of the items 510, 520, and 530 which makes it possible for the user to delete the corresponding item.

As shown in part (B) of FIG. 6, the control unit 100 may control such that a selection icon 503 (e.g. check box □) is presented near a side (e.g. one of top, bottom, left, and right sides) which makes it possible for the user to select the corresponding item for deletion afterward with an additional delete command (e.g. execution of delete option).

As shown in part (C) of FIG. 6, the control unit 100 may control such that the items 510, 520, and 530 are presented with certain visual effects (e.g. engraving, embossing, shadowing, and gradation) and marked, when selected, with a selection mark (e.g. notch √) which make it possible for the user to delete the clipped data corresponding to the items with an additional deletion command.

As shown in part (D) of FIG. 6, the control unit 100 may control such that a recycling bin item 507 is presented at a corner of the clipboard window 500 which makes it possible to delete the items 510, 520, and 530 selectively. In part (D) of FIG. 6, the control unit 100 provides the recycling bin item 507 at a corner of the clipboard 500 to make it possible for the user to select and move at least one item to the recycling bin item 507 (e.g. drag and drop) to delete the corresponding clipped data.

According to an embodiment of the present invention, the edit mode may be implemented in various ways and provide a certain edit mode according to the user configuration.

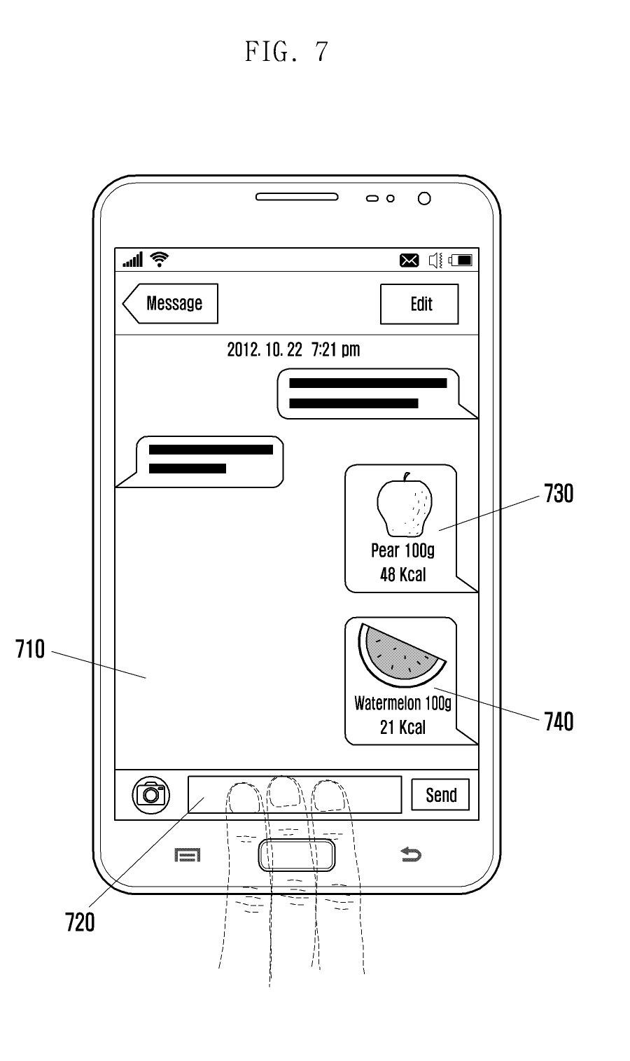

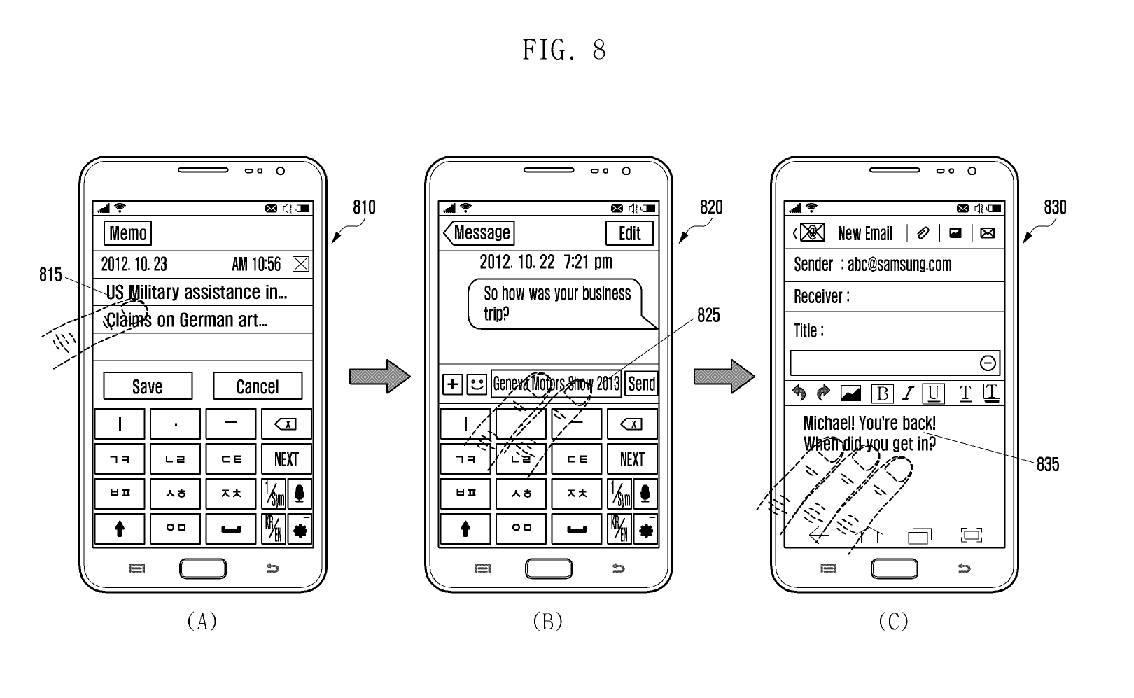

FIGS. 7 and 8 are diagrams illustrating screen displays of a procedure of pasting clipped data in response to a user input in the electronic device according to an embodiment of the present invention. Although the description is made under the assumption that the user gesture is made with finger(s) and/or dedicated touch pen (e.g. stylus pen) in the following description, any other means capable of making an input on the touch panel 140 can be used.

Referring to FIGS. 7 and 8, the user may clip (copy or cut) one or more objects into the clipboard and then paste the objects to a certain page. The control unit 100 may detect a user gesture made at an area of the page displayed on the display unit 130 through the touch panel 140. The user gesture may consist of one or more touch points and be made to invoke the clipped data from the clipboard 115 and paste the clipped data to an area (e.g. paste area). The user gesture may be made in such a way of touching the paste area or hovering an input tool above the paste area. The page on which the clipped data is pasted may be the page editable by the user (e.g. page on which the user may add, modify, and delete objects) or a home screen.

As shown in FIG. 7, the user input gesture may be made to have one or more touch points in the paste area 720 (e.g. text input window of a messenger application) of the page displayed on the display panel 130.

For example, the user may make a touch gesture having one touch point (e.g. one finger single touch) to paste the first clipped data to the paste area. If the touch gesture having one touch point is detected on the paste area 720, the control unit 100 invokes the first clipped data identified with one touch point from the clipboard 115 and pastes the clipped data to the area of the page whether the touch gesture is detected. For example, the control unit 100 may control such that the first clipped data 730 is identified with one touch point on the execution screen 710 of the messenger application in response to the user touch gesture.

The user also may make a touch gesture which is different from the touch gesture made for pasting the first clipped data 730 by changing the number of touch points (e.g. having two touch points (two finger multi-touch) or three touch points (three finger multi-touch)) used to paste other clipped data (e.g. second clipped data and third clipped data). If the touch gesture is detected at the paste area 720, the control unit invokes the clipped data identified with the number of touch points from the clipboard 115 and pastes the clipped data at the area on the corresponding page in response to the touch gesture. For example, the control unit 100 may control such that the second clipped data 740 is identified with two touch points and the third clipped data identified with three touch points in the execution screen 710 of the messenger application in series.

As shown in FIG. 7, the plural objects selected according to the user input may be pasted on the same page (e.g. execution screen of an application) or different pages (e.g. execution screens of different applications).

As shown in FIG. 8, the same or different objects may be pasted onto the execution screen 810 of the first application (e.g. memo application), the execution screen 820 of the second application (e.g. messaging application), and the execution screen 830 of the third application (e.g. email application).

As shown in part (A) of FIG. 8, the user may paste the clipped data 815 to the execution screen 810 of the first application by making the touch gesture having one touch point (i.e. one finger single touch). The control unit 100 may invoke the clipped data 815 identified with one touch point and paste the clipped data 815 onto the paste area in response to the touch gesture having one touch point. According to an embodiment, the control unit 100 may process the clipped data to generate an object (e.g. text, image, data, URL, and content) to be presented on the page and paste the converted object at the corresponding area of the page.

As shown in part (B) of FIG. 8, the user may paste the clipped data 815 to the execution screen 810 of the first application and then switch the first application execution screen 810 to the second application execution screen 820. The user may paste the corresponding clipped data 825 by making a touch gesture having two touch points (i.e. two finger multi-touch) on the second application execution screen 820. The control unit 100 may invoke the clipped data 825 identified with two touch points from the clipboard 115 and paste the clipped data 825 at the paste area in response to the user touch gesture having the two touch points.

Likewise, as shown in part (C) of FIG. 8, the user may switch the second application execution screen 820 to the third application execution screen. The user may paste the clipped data 835 by making a touch gesture having three touch points (i.e. three-finger multi-touch) on the third application execution screen 830. The control unit 100 may invoke the clipped data 835 identified with three touch points from the clipboard 115 and paste the clipped data 835 at the paste area in response to the tough gesture having three touch points.

FIG. 8 is directed to the case where different clipped data is pasted onto the execution screens of different applications. In an embodiment of the present invention, however, the same clipped data may be pasted onto different application execution screens. For example, the user may make the touch gesture having the same number of touch points (e.g. two-finger multi-touch) repeatedly on different application execution screens, and the control unit 100 may paste the same clipped data on the respective application execution screens in response to the touch gestures.

In an embodiment of the present invention, it is possible to clip or paste an object immediately upon detecting the touch gesture for clipping or pasting an object and a number of touch points of the touch gesture. However, the present invention is not limited thereto.

In an embodiment of the present invention, the method for clipping (copying or cutting) an object based on a touch gesture may provide a list of selectable items including copy, cut, expand, share, and search according to a predetermined touch gesture (e.g. long press over predetermined time) for clipping an object. The user may select the copy or cut item to clip the corresponding object.

If the user makes a touch gesture having one or more touch points based on a predetermined scheme (e.g. long press over predetermined time) for pasting an object, a list of items selectable for pasting clipped data and presenting stored clipped data (displaying clipboard window) is provided. The user may select the paste menu item from the list to paste the clipped data or select the clipboard window display menu item to display the clipboard window including stored clipped data.

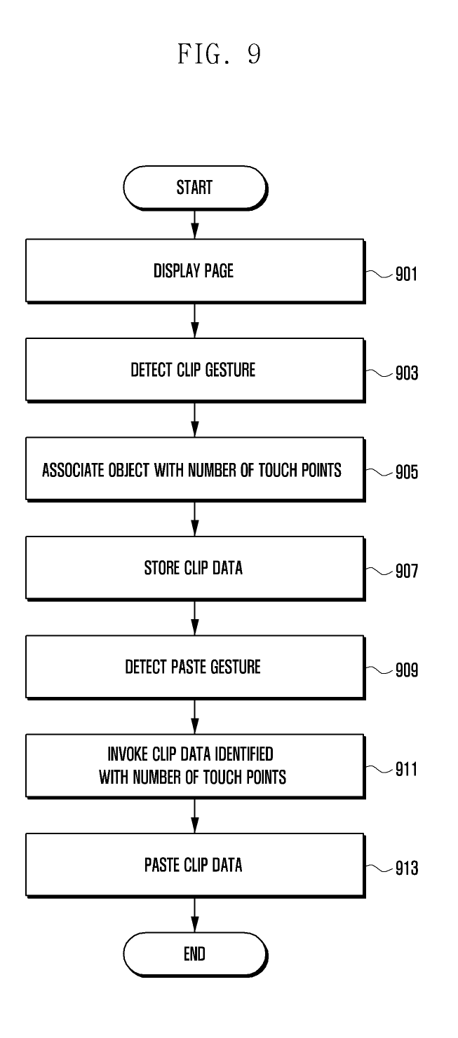

FIG. 9 is a flowchart illustrating a clipboard function control method of the electronic device according to an embodiment of the present invention.

Referring to FIG. 9, the control unit 110 executes an application and displays a page in response to a user request at step 901. The page may include one or more objects.

The control unit 100 may detect a clip gesture at step 903 for clipping (copying or cutting) an object in the state that the page is displayed.

If the clip gesture is detected, the control unit 100 associates the number of touch points of the clip gesture with the object at step 905. For example, if the clip gesture is detected, the control unit 100 checks one or more touch points constituting the clip gesture. The control unit 100 associates the number of touch points with the object to which the touch gesture for clipping the object is made.

The control unit 100 stores the object associated with the number of touch points as clipped data in the clipboard 115 at step 907. If the clip gestures different in number of touch points are made to different objects in series, the control unit 100 may associate the objects with the numbers of touch points of the clip gestures made thereto and store them as clipped data on the clipboard. For example, the user may make a clip gesture to the first object with one finger (number of touch points=1) and in this case, the control unit 100 associates the first object with 1 indicating the number of touch points associated with the clipped data. The user also may make a clip gesture to the second object with two fingers (number of touch points=2) and in this case, the control unit 100 associates the second object with 2 indicating the number of touch points associated with the clipped data. The user also may make a clip gesture to the third object with three fingers (number of touch pints=3) and in this case, the control unit 100 associates the third object with 3 indicating the number of touch points associated with the clipped data. Here, the first to third objects may be the objects provided on the same page or different pages.

After associating the object with the number of touch points, the control unit 100 detects a paste gesture for pasting the clipped data stored on the clipboard 115 at step 909. Here, the paste gesture may be made on the current page or another page which may be editable (e.g. user may paste an object thereto).

If the paste gesture is detected, the control unit 100 invokes the clipped data identified with the number of touch points of the paste event from the clipboard 115 at step 911. If the paste event is detected, the control unit 100 may check the number of touch points of the paste gesture. After checking the number of touch points, the control unit 100 searches for the clipped data identified with the same number of touch points. If the corresponding clipped data is retrieved, the control unit 100 invokes the clipped data from the clipboard 115. If no clipped data is identified with the number of touch points, the control unit 100 may control the display panel 130 to output an error message and/or a message prompting retry of the paste gesture. Here, the error message may be the output of a predetermined audio signal.

The control unit 100 pastes the retrieved clipped data at the area where the paste gesture is detected at step 913. For example, the control unit 100 controls such that the clipped data is loaded from the clipboard 115 and presented at the position where the paste gesture is made. If a series of paste gestures different in number of touch points is made by the user, the control unit 100 may paste the clipped data identified with the numbers of touch points in the series in the order of detections of the paste gestures.

For example, the user may make a paste gesture with one finger (number of touch points=1) at the paste area and in this case, the control unit 100 invokes the first clipped data identified with one touch point in response to the paste gesture. The user also may make a paste gesture with two fingers (number of touch points=2) at the paste area of the same or another page and in this case, the control unit 100 invokes the second clipped data identified with two touch points in response to the paste gesture. The user also may make a paste gesture with three fingers (number of touch points=3) at the paste area of the same or still another page and in this case, the control unit 100 invokes the third clipped data identified with three touch points in response to the paste gesture.

In the case that the paste gestures of the same number of touch points are made in series on a certain page, the control unit 100 pastes the same clipped data repeatedly in series on the corresponding page. Also, in the case multiple paste gestures with different numbers of touch points are made on a certain page, the control unit 100 pastes the multiple clipped data identified with the numbers of the touch points in series on the corresponding page.

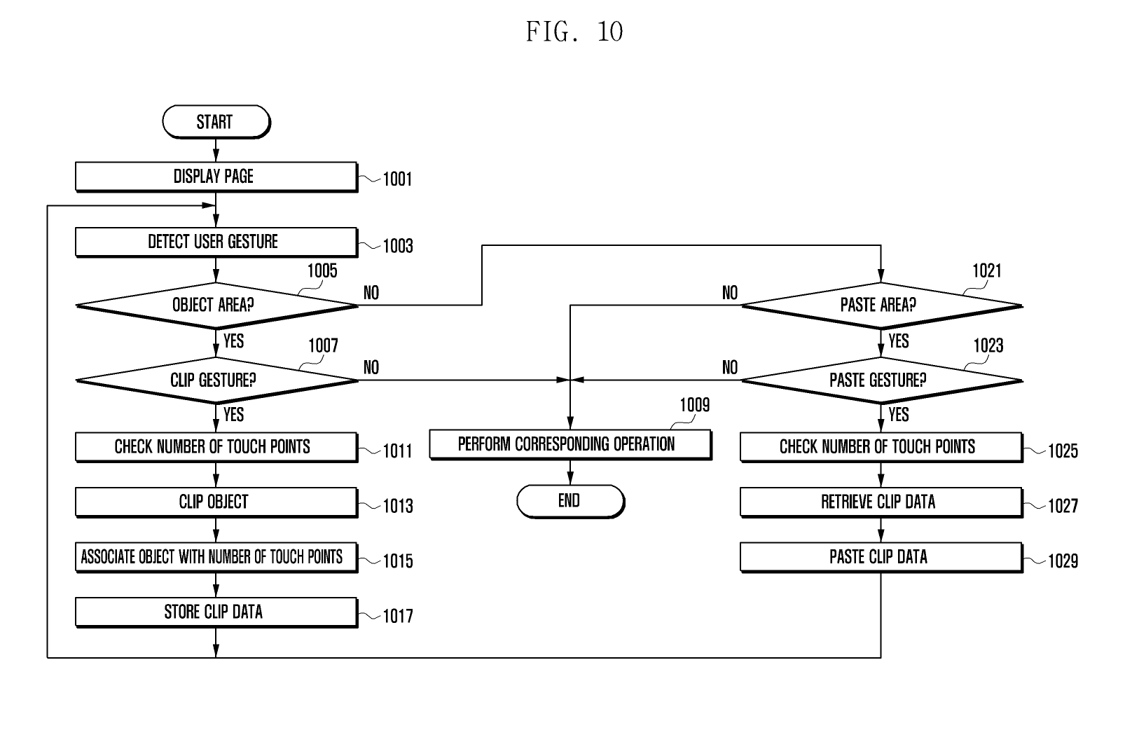

FIG. 10 is a flowchart illustrating a clipboard function control method of an electronic device according to an embodiment of the present invention.

Referring to FIG. 10, the control unit 10 displays a page of an application in response to a user request at step 1001. The page may include one or more objects.

If a user gesture is detected in the state that the page is displayed at step 1003, the control unit 100 determines whether there is any object at the position where the user gesture is detected at step 1005.

If it is determined that the user gesture is detected at the object area at step 1005, the control unit 100 determines whether the user gesture is the clip gesture at step 1007. For example, the control unit 100 may determine whether the user gesture is the gesture predetermined for clipping an object (e.g. long press or double tap onto the object).

If it is determined that the user gesture is not the clip gesture at step 1007, the control unit 100 controls to perform an step corresponding to the user input at step 1009. For example, the control unit 100 may control the step of moving an object, executing the application corresponding to the object, and turning the page in response to the user gesture.

If it is determined that the user input is the clip event at step 1007, the control unit 100 checks the number of touch points of the user gesture (clip gesture) at step 1011 and clips the object at the area where the clip gesture is detected at step 1013. For example, the control unit 100 may cut or copy of the object according to the type of the clip gesture.

The control unit 100 may associate the clipped object with the number of touch points at step 1015 and store it as the clipped data at step 1017. For example, the control unit 100 associates the copied or cut object with the number of touch points to generate the clipped data and store the clipped data in the clipboard 115.

Afterward, the control unit 100 may repeat generating and storing clipped data in response to the clip gestures made on the current page or after switching to another page. The control unit 100 may control pasting the object in response to a user's paste gesture.

If it is determined that the user gesture is not detected at the object area at step 1005, the control unit 100 determines whether the user gesture is detected at a paste area at step 1021. For example, the control unit 100 may determine whether the position where the user gesture is detected is an editable area such as text input window (where it is possible to paste an object).

If it is determined that the user gesture is not detected at the paste area at step 1021, the control unit 100 controls to perform the step corresponding to the user gesture at step 1009. For example, the control unit 100 may control the step of turning the page, executing the application corresponding to the object, and moving an object in response to the user gesture.

If it is determined that the user gesture is detected at the paste area at step 1021, the control unit 100 determines whether the user gesture is a paste gesture predefined for pasting the data clipped in the clipboard at a certain area (e.g. long press or double tap at the paste area) at step at step 1023.

If it is determined that the user gesture is not the paste gesture at step 1023, the control unit 100 controls to perform the step corresponding to the user gesture at step 1009. For example, the control unit 100 may control such that the text corresponding to the user gesture is presented at the paste area (e.g. text input window).

If it is determined that the user gesture is the paste gesture at step 1023, the control unit 100 checks the number of touch points of the user gesture (paste gesture) at step 1025 and retrieves the clipped data in response to the paste gesture at step 1027. For example, the control unit 100 checks the number of touch points of the paste gesture and retrieves the clipped data identified with the number of touch points from the clipboard 115.

The control unit 100 may paste the retrieved clipped data at the paste area at step 1029.

Afterward, the control unit 100 may perform an step of pasting other clipped data on the current page or onto another page after switching pages or clipping other object in response to the user gesture as described above.

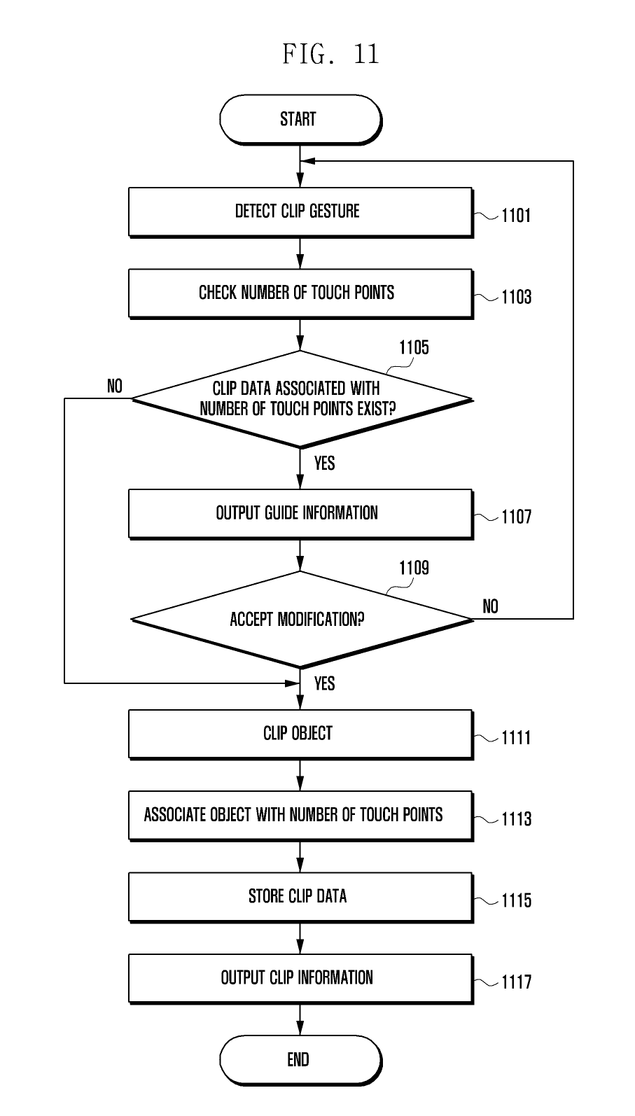

FIG. 11 is a flowchart illustrating a clipboard function control method of an electronic device according to an embodiment of the present invention. Particularly, FIG. 11 is directed to the step of clipping an object in response to the clip gesture made by the user.

Referring to FIG. 11, if the clip gesture is detected at step 1101, the control unit 100 checks the number of touch points of the clip gesture at step 1103. For example, the control unit 100 may detect a user gesture (e.g. long press and double tap) preconfigured as the clip gesture at an object area. The user may make the clip gesture with one or more touch points using an input means and the control unit 100 checks the number of touch points of the clip gesture.

The control unit 100 may determine whether any clipped data identified with the number of detected touch points exists at step 1105. For example, the control unit 100 may determine whether there is any clipped data identified with the number of detected touch points in the clipboard 115.

If there is no clipped data identified with the number of detected touch points at step 1105, the procedure goes to step 1111.

If there is any clipped data identified with the number of detected touch points at step 1105, the control unit 100 outputs guide information at step 1107. For example, if there is any object identified with the number of touch points of the user gesture, the control unit 100 may output the guide information asking visually (e.g. in the form of popup) and/or audibly (in the form of audio output) whether to modify the object. According to an embodiment, the control unit 100 may provide the announcement message “Another object has been registered in association with the number of touch points of the gesture already. Replace the old object?” and guide information including items allowing for a choice of one of accept and reject to the modification of the object in a guide window (e.g. a YES/NO selection item).

The control unit 100 determines whether the modification is accepted or rejected at step 1109.

If a user input for rejecting the modification is detected, the control unit 100 hides the guide information and returns the procedure to step 1101.

If a user input for accepting the modification is detected, the control unit 100 hides the guide information and clips (e.g. cut or copy) the object 1111 targeted by the clip gesture.

The control unit 100 associates the clipped object with the number of touch points at step 1113 and stores the clipped data into the clipboard 115 at step 1115.

The control unit 100 outputs the clip information announcing, visually and/or audibly, that the object as the target of the clip gesture is registered with the clipboard 115 in storing the clipped data at step 1117.

According to an embodiment of the present invention, operations 1105 to 1109 may be provided optionally according to the user configuration. For example, if the user configures an overlap protection option to the same number of touch points, operations 1105 to 1109 are omitted and thus the procedure jumps from step 1103 to step 1111. If the overlap protection option is not configured, the old clipped data registered in association with the number of touch points is replaced with a new object as the target of the clip gesture automatically.

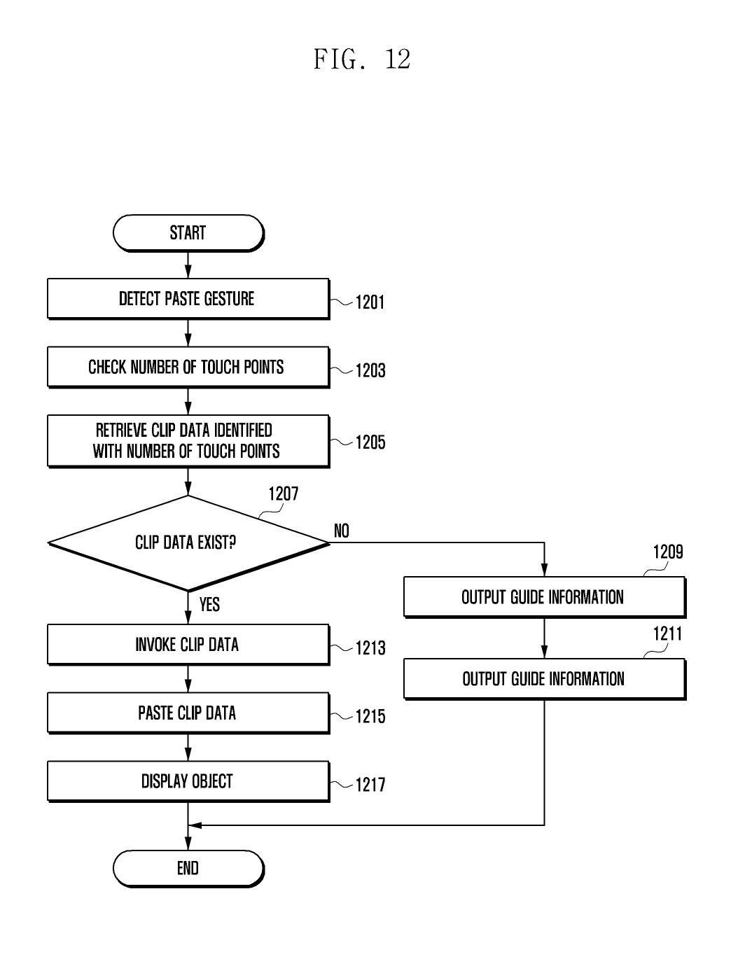

FIG. 12 is a flowchart illustrating a clipboard function control method of an electronic device according to an embodiment of the present invention. Particularly, FIG. 12 is directed to the step of pasting an object in response to the paste gesture of the user.

Referring to FIG. 12, if the paste gesture is detected at step 1201, the control unit 100 checks the number of touch points of the paste gesture at step 1203. For example, the control unit 100 may detect a user gesture (e.g. long press and double tap) preconfigured as the clip gesture at the paste area. The user may make the paste gesture with one or more touch points using an input means and, in this case, the control unit 100 checks the number of touch points of the paste gesture.

The control unit 100 searches for (retrieves) the clipped data identified with the number of detected touch points at step 1205 and determines whether there is any clipped data identified with the number of touch points at step 1207. For example, the control unit 100 may check whether any clipped data registered in association with the detected number of touch points among the clipped data stored in the clipboard 115.

If there is no clipped data identified with the number of detected touch points at step 1207, the control unit 100 outputs guide information at step 1209. For example, the control unit 100 may output the guide information notifying, visually (e.g. in the form of popup) and/or audibly (in the form of audio output), of the absence of clipped data identified with the number of touch points of the user gesture. According to an embodiment, the control unit 100 may provide the guide information including an announcement message “There is no clipped data identified with the number of touch points of the input gesture. Display clipboard window?” through a guide window. The control unit 100 also may provide a clipboard window automatically along with the announcement message. The control unit 100 may also provide the announcement message “Display clipboard window?” and guide information including items allowing for choice of one of accept and reject to the display of the clipboard window 500 (e.g. a YES/NO selection item). The user may check the clipped data stored previously in the clipboard and the number of touch points which is registered with the clipped data intuitively through the clipboard window 500.

The control unit 100 controls to perform the corresponding step after outputting the guide information at step 1211. For example, the control unit 100 may output the clipboard window 500 or perform an step in response to the paste gesture different from the previous paste gesture in number of touch points.

If there is any clipped data identified with the number of detected touch points at step 1207, the control unit 100 invokes the clipped data identified with the number of touch points at step 1213.

The control unit 100 pastes the invoked clipped data at the paste area where the paste gesture has been detected at step 1215 and presents the object at the very position at step 1217. For example, the control unit 100 processes the invoked clipped data to generate the object (e.g. text, image, data, URL, and content) to be pasted on the page (paste area). The control unit 100 pastes the converted object at the paste area of the page such that the object is presented thereon.

As described above, the clipboard function control method and apparatus of the present invention is capable of clipping (e.g. copying and cutting) a plurality objects into the clipboard 115 in series according to the clip gestures made by the user, the clip gestures being different in number of touch points. Also, the clipboard function control method and apparatus of the present invention is capable of pasting a plurality of clipped data stored in the clipboard 115 in response to the paste gestures made by the user, the paste gestures being different in number of touch points. Also, the clipboard function control method and apparatus of the present invention is capable of allowing the user to perform the clipping and pasting actions alternately and paste the objects registered with the same number of touch points repeatedly. Also, the clipboard function control method and apparatus of the present invention is capable of facilitating execution of the clipboard function and simplifying the actions of copying, cutting, and pasting objects.

The above embodiments of the present invention can be implemented by hardware, firmware, software, or any combination thereof. Some or all of the modules may be configured into one entity responsible for the same functions of the corresponding modules. According to various embodiments of the present invention, the operations may be performed in series, repetitively, or in parallel. Some operations may be omitted, and other operations are further included.

The above-described various embodiments of the present invention can be implemented in the form of computer-executable program commands and stored in a computer-readable storage medium. The computer readable storage medium may store the program commands, data files, and data structures in individual or combined forms. The program commands recorded in the storage medium may be designed and implemented for various embodiments of the present invention or used by those skilled in the computer software field.

The computer-readable storage medium includes magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The program commands include the language code executable by computers using the interpreter as well as the machine language codes created by a compiler. The aforementioned hardware device can be implemented with one or more software modules for executing the operations of the various embodiments of the present invention.

As described above, the clipboard function control method and apparatus of the present invention is capable of storing the objects copied or cut by the user in association with the number of touch points of the user gestures made for clipping the objects. The clipboard function control method and apparatus of the present invention is capable of allowing the user to clip a plurality of contents into the clipboard in a simple and quick manner. The clipboard function control method and apparatus of the present invention is capable of allowing the user to copy or cut contents distributed on different pages efficiently without any complex procedure.

The clipboard function control method and apparatus of the present invention is capable of pasting a plurality of contents identified with the numbers of touch points of user gestures made for copying the contents in series according to the numbers of touch points of the user gestures for pasting the contents.

The clipboard function control method and apparatus of the present invention is capable of facilitating execution of the clipboard function, resulting in improvement of user convenience, device usability, and product competitiveness.

Although certain embodiments of the invention have been described using specific terms, the specification and drawings are to be regarded in an illustrative rather than a restrictive sense in order to help understand the present invention. Thus the scope of the invention should be determined by the appended claims and their legal equivalents rather than the specification, and various alterations and modifications within the definition and scope of the claims are included in the claims.

What is claimed is:

1. A clipboard function control method of an electronic device, the method comprising:
detecting a user gesture on a page;
checking a number of touch points of the user gesture; and
processing an object in association with the number of touch points of the user gesture,
where processing the object comprises one of storing the object in association with the number of touch points as clipped data and pasting the clipped data identified with the number of touch points.

2. The method of claim 1, wherein storing the object comprises:
determining, when the user gesture is a clip gesture made at an object area, the number of touch points of the clip gesture;
associating the object positioned at the object area with the number of touch points of the clipped data; and
storing the clipped data in the clipboard.

3. The method of claim 1, wherein pasting the clipped data comprises:
determining, when the user gesture is a paste gesture made at a paste area, the number of touch points of the paste gesture;
retrieving the clipped data identified with the number of touch points of the paste gesture; and
pasting the retrieved clipped data to the paste area.

4. The method of claim 1, wherein detecting the user gesture comprises:
determining, when the user gesture is detected on the page, whether the user gesture is detected at an object area or a paste area;
determining, when the user gesture is detected at the object area, the user gesture as a clip gesture; and
determining, when the user gesture is detected at the paste area, the user gesture as a paste gesture.

5. The method of claim 2, wherein associating the object comprises:
clipping the object positioned at the object area in response to the clip gesture; and
associating the clipped object with the number of touch points to generate the clipped data.

6. The method of claim 2, wherein associating the object comprises determining whether any clipped data previously stored in association with the number of touch points exists.

7. The method of claim 6, further comprising:
outputting, when any clipped data previously stored in association with the number of touch points exists, a guide information; and
storing, when a change accept command is input based on the guide information, the object in association with the number of touch points.

8. The method of claim 2, wherein storing the clipped data comprises outputting, when the clipped data is stored, clip information.

9. The method of claim 3, wherein retrieving the clipped data comprises:
searching the clipboard for the clipped data identified with the number of touch points; and
retrieving, when the clipped data is found, the clipped data from the clipboard.

10. The method of claim 9, wherein pasting the retrieved clipped data comprises pasting the invoked clipped data to the paste area where the paste gesture is detected, the clipped data being presented as an object at the paste area.

11. The method of claim 9, further comprising outputting, when no clipped data exists, a guide information.

12. The method of claim 1, further comprising outputting a clipboard window on the page in response to the user gesture made for displaying the clipboard window.

13. The method of claim 12, further comprising:
executing an edit mode for editing the clipped data in response to the user gesture made in the clipboard window; and
editing one or more clipped data in response to the user gesture in the edit mode.

14. The method of claim 13, wherein editing one or more clipped data comprises deleting one or more clipped data edited in the edit mode from the clipboard.

15. The method of claim 1, where storing the object comprises storing a plurality of objects in association with different numbers of the touch points of the user gestures made to different objects.

16. The method of claim 1, wherein pasting the clipped data comprises pasting a plurality of clipped data identified with the same number of the touch points in series in response to the user gestures having the same number of touch points which are made in series.

17. The method of claim 1, further comprising pasting a plurality of objects identified with different numbers of touch points in series in response to the user gestures made with different number of touch points.

18. A clipboard function control method of an electronic device, the method comprising:
detecting a user gesture made on a page;
determining a type of the user gesture and a number of touch points of the user gesture;
clipping, when the user gesture is a clip gesture made at an object area, an object in response to the clip gesture;
storing the clipped object in association with the number of touch points; and
pasting, when the user gesture is a paste gesture made at a paste area, the object identified with the number of touch points at the paste area.

19. An electronic device comprising:
a display panel which displays a page;
a storage unit including a clipboard for storing one or more clipped data; and
a control unit configured to control storing an object clipped in response to a user gesture made on the page in association with a number of the user gesture and retrieving the clipped data identified with the number of touch points of the user gesture from the clipboard for pasting.

20. The electronic device of claim 19, wherein the control unit determines, when the user gesture is detected at an object area, the user gesture as a clip gesture, clips the object positioned at the object area in response to the clip gesture, and stores the clipped object in association with the number of touch points of the clip gesture as clipped data into the clipboard.

21. The electronic device of claim 19, wherein the control unit determines, when the user gesture is detected at a paste area, the user gesture as a paste gesture and retrieves the clipped data identified with the number of touch points of the paste gesture, and pastes the clipped data to the paste area in response to the paste gesture.

22. The electronic device of claim 21, wherein the control unit searches the clipboard for the clipped data identified with the number of touch points, retrieves, when the clipped data is found, the clipped data from the clipboard, and pastes the clipped data to the paste area where the paste gesture is detected.

23. The electronic device of claim 19, wherein the control unit controls outputting a clipboard window on the page in response to a user gesture made for displaying the clipboard window and executing an edit mode for editing the clipped data in response to the user gesture made in the clipboard window.

24. The electronic device of claim 23, wherein the control unit deletes one or more clipped data selected in response to the user gesture from the clipboard in the edit mode.

25. The electronic device of claim 23, wherein the one or more clipped data stored in the clipboard are associated with different numbers of touch points.

26. An electronic device comprising:
a display panel which displays a page;
a touch panel which detects a user gesture;
a storage unit which stores at least one program; and
at least one processor which executes at least one program to control a clipboard function of the electronic device,
wherein the at least one program comprises:
detecting a user gesture made on a page;
determining a type of the user gesture and a number of touch points of the user gesture;
clipping, when the user gesture is a clip gesture made at an object area, an object in response to the clip gesture;
storing the clipped object in association with the number of touch points; and
pasting, when the user gesture is a paste gesture made at a paste area, the object identified with the number of touch points at the paste area.
